(19) United States
(12) Patent Application Publication
(10) Pub. No.: US 2020/0023735 A1
(43) Pub. Date: Jan. 23, 2020

(54) FRONT DIFFERENTIAL WITH WEDGE CLUTCH

(71) Applicant: SCHAEFFLER TECHNOLOGIES AG & CO. KG, HERZOGENAURACH (DE)

(72) Inventor: Brian LEE, York, SC (US)

(21) Appl. No.: 16/037,457

(22) Filed: Jul. 17, 2018

(51) Int. Cl. B60K 23/08; B60K 17/35; B60K 17/02

(52) U.S. Cl. CPC B60K 23/0808; B60K 2023/0833; B60K 17/02; B60K 17/35

(57) ABSTRACT

A front differential for use with an all-wheel-drive vehicle includes an input member, and an output member selectively engaged to power rear wheels of the vehicle. The differential also includes first and second axle hubs operably coupled to the input member by a differential mechanism. A wedge clutch is configured to selectively couple the input and output members to route power to the rear wheels. The wedge clutch has an outer race fixed to the input member, an inner race fixed to the output member, and a wedge element radially disposed between the inner and outer races and actuatable to couple the inner and outer races creating a power flow path between the input and output members.

### TECHNICAL FIELD

The present disclosure relates to front differentials and more specifically to front differentials that include disconnect clutches.

### BACKGROUND

Many vehicles include all-wheel drive to increase traction. A typical light-duty all-wheel-drive powertrain includes a transversely mounted engine and transmission. The transmission is operably coupled to a power-transfer unit that selectively sends power to rear wheels of the vehicle. The power-transfer unit include may one or more clutches configured to send power to the rear wheels when engaged and to not send power when disengaged.

### SUMMARY

According to one embodiment, a front differential for use with an all-wheel-drive vehicle includes an input member, and an output member selectively engaged to power rear wheels of the vehicle. The differential also includes first and second axle hubs operably coupled to the input member by a differential mechanism. A wedge clutch is configured to selectively couple the input and output members to route power to the rear wheels. The wedge clutch has an outer race fixed to the input member, an inner race fixed to the output member, and a wedge element radially disposed between the inner and outer races and actuatable to couple the inner and outer races creating a power flow path between the input and output members.

According to another embodiment, a differential includes an input member, first and second axle hubs supported for independent rotation relative to each other and operably coupled to the input member, and an output shaft configured to connect with a power-transfer unit. The output shaft circumscribes the second axle hub and has an outer surface defining at least one groove. A side plate of the differential is fixed to the input member and defines an axially extending ring that circumscribes the output shaft. The ring defines a first cam surface. A clutch element of the differential is radially disposed between the output shaft and the ring. The clutch element includes at least one projection received in the at least one groove and a second cam surface engaging the first cam surface.

According to yet another embodiment, a wedge clutch includes an inner race, an outer race circumscribing the inner race, and a plurality of arcuate segments arranged in pairs and circumferentially disposed around the inner race such that each pair forms a section of a wedge cylinder that includes springs disposed between the sections to bias the arcuate segments of each pair towards each other. The springs bias the arcuate segments of each pair towards each other to contract the wedge cylinder onto the inner race so that the races lock in response to relative rotation between the outer race and the wedge cylinder.

### BRIEF DESCRIPTION OF THE DRAWINGS

FIG. 1 is a schematical diagram of an all-wheel-drive vehicle.

FIG. 2 is a cross-sectional view of a front differential.

FIG. 3 is partial perspective view of the front differential showing a differential mechanism and portions of a disconnect clutch.

FIG. 4A is an axial cross-sectional view of the disconnect clutch with a wedge element in a locked position.

FIG. 4B is an axial cross-sectional view of the disconnect clutch with the wedge element in an unlocked position.

FIG. 5A is a top cross-sectional view of the disconnect clutch with the wedge element in the locked position.

FIG. 5B is a top cross-sectional view of the disconnect clutch with the wedge element in the unlocked position.

FIG. 6 is a perspective view of an actuator arrangement for the disconnect clutch.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure presents one or more embodiments of a front differential for use with all-wheel-drive vehicles. The front differential not only distributes torque between the front driving wheels but also includes a disconnect clutch configured to couple and decouple the rear driving wheels from a vehicle powerplant, e.g., an engine.

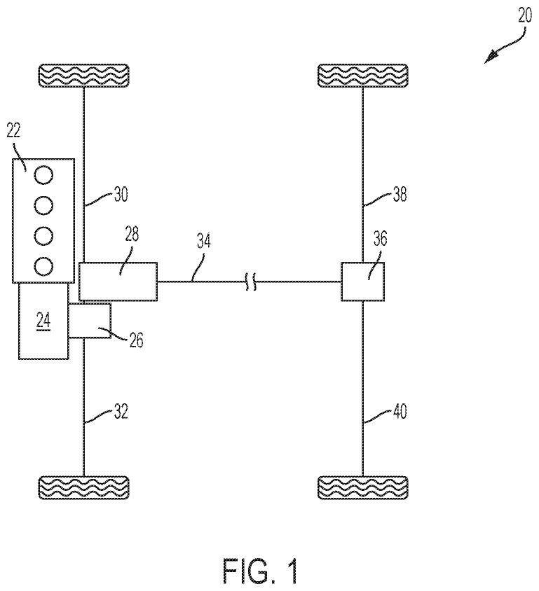

FIG. 1 illustrates an example vehicle 20, such as a passenger car, crossover, or SUV, that includes a front differential of this disclosure. The vehicle 20 includes a transversely mounted engine 22 and a transmission 24 that receives power from the engine. A front differential 26 is mounted to the transmission 24 and includes an input member that is coupled to a transmission output by gearing, belt or chain drive, or other suitable means. The differential 26 includes left and right axle hubs operably coupled to the input member by a differential mechanism that allows for relative rotation between the axles 30, 32, which are connected to the axle hubs by a spline or other suitable connection.

The differential 26 includes a third output, typically in the form of an output shaft, that is connected with an input of the power-transfer unit 28. The power-transfer unit 28 receives power from the front differential 26 and routes it to the rear wheels. In this application, the power-transfer unit 28 may be a simple gearbox as the disconnect clutch for the rear wheel is disposed within the front differential 26. A rear differential 36 is connected to the power-transfer unit 28 by a driveshaft 34. Power is delivered from the rear differential 36 to the rear wheels by rear axle shafts 38 and 40.

The vehicle 20 is propelled in a front-drive mode when the disconnect clutch of the front differential 26 is open and is propelled in an all-wheel-drive mode when the disconnect clutch is closed. Providing the disconnect clutch in the front differential as opposed to the power-transfer unit may provide a smaller package and reduces the cost and complexity of the power-transfer unit 28.

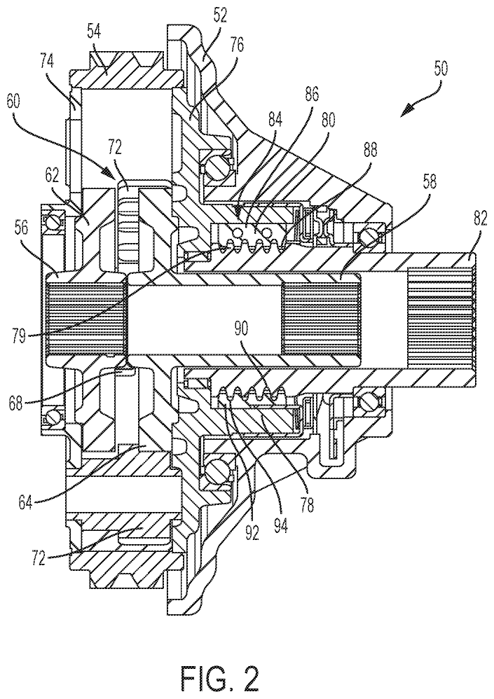

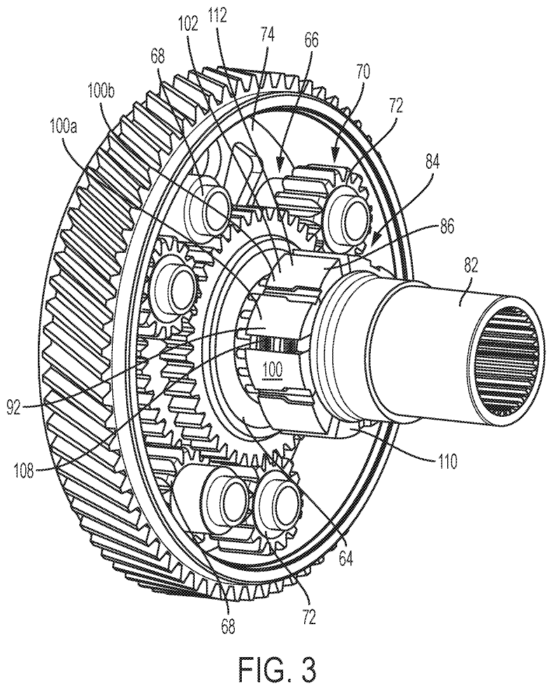

FIGS. 2 through 6 describe example front differentials that include a disconnect clutch. Referring to FIGS. 2 and 3, the front differential 50 includes a housing 52 that may be adapted to mount with a transmission or other support structure of the vehicle. An input member is supported for rotation within the housing 52 and is configured to receive power generated by a powerplant. The input member may be the illustrated ring gear 54, a chain driven sprocket or the like.

The differential 50 includes axle hubs 56 and 58 that connect with the front axle shaft. The axle hubs 56, 58 may define internal splines that engage with external splines formed on the axle shafts to connect the front axle shafts to the differential 50. The axle hubs 56 and 58 may be coaxial and are supported for rotation within the ring gear 54. Power received by the ring gear 54 is conveyed to the axle hubs 56 and 58 by a differential mechanism 60 that allows speed differences between the axle hubs 56, 58. Many types of differential mechanisms are known such as box-bevel gears, various planetary arrangements, and the like. In the illustrated embodiment, the differential 50 has a planetary differential mechanism 60.

The planetary differential mechanism 60 includes a pair of planetary systems each associated with one of the front axle shafts. The axle hub 56 is fixed to a sun gear 62. The axle hub 56 and the sun gear 62 may be integrally formed as a single piece. A first set 66 of planet gears 68 are circumferentially arranged around the sun gear 62 such that the sun gear 62 meshes with each of the planet gears 68. The first set 66 is supported by a planet carrier such as a first side plate 74 that is fixed to the ring gear 54. A second set 70 of planet gears 72 are circumferentially arranged around a sun gear 64 such that the sun gear 64 meshes with each of the planet gears 72. The second set 70 is supported by a planet carrier such as the second side plate 76. The differential mechanism 60 is shown as an open differential, however, in other embodiments the differential 50 may include a limited-slip differential mechanism or a locker.

The differential 50 includes an output member configured to supply power to another component such as a power-transfer unit. In the illustrated embodiment, the output member is an output shaft 82 supported for rotation within the housing 52. The output shaft 82 may be mounted coaxially with the axle hubs 56, 58 and may define a hollow center through which the axle hub 58 extends.

A disconnect clutch 84 of the differential 50 is configured to selectively couple the input and output members creating a rear-axle power flow path through the differential 50. The illustrated disconnect clutch 84 is known as a wedge clutch. The disconnect clutch 84 includes an outer race fixed to the input member and an inner race fixed to the output member. The inner and outer races may be a component or may be a machined surface. For example, the outer race may be a component that is fixed to the input member or may be a surface formed on a component fixed to the input member, similarly, the inner race may be a component that is fixed to the output member or maybe a surface formed on the output member. A wedge element 86 is radially disposed between the inner and outer races and is configured to selectively lock the inner and outer races when the clutch is 84 engaged.

In the illustrated embodiment, the outer race is an axially extending ring 78 of the side plate 76, and the inner race is a surface 79 machined onto the outer diameter of the output shaft 82. The wedge element 86 is radially disposed between the output shaft 82 and the ring 78. The wedge element 86 is radially expandable between a contracted position in which an inner surface of the wedge element 86 is seated on the output shaft 82 and an expanded position in which the inner surface is slightly spaced from the output shaft 82. The clutch 84 is engageable when the wedge element 86 is in the contracted position and is not engageable when in the expanded position. The clutch 84 can be engaged and disengaged by moving the wedge element 86 between the expanded and contracted positions.

The inner surface of the wedge element 86 may define a plurality of axially spaced circumferential projections 88 that are received in a plurality of axially spaced circular grooves 90 defined in the outer surface of the output shaft 82. When the clutch 84 is engaged, friction between the projections 88 and the grooves 90 rotationally lock the wedge element 86 to the output shaft 82. The wedge element 86 includes a cam surface 92 that engages and cooperates with a cam surface 94 defined on the ring 78. The cam surface 94 defines a plurality of ramps 116 configured to engage with lobes 80 of the cam surface 92 to wedge the wedge element 86 between the ring 78 and the output shaft 82 responsive to the wedge element 86 and the ring 78 rotating relative to each other. The wedging action induced by the cam surfaces 92, 94 tightly clamps the wedge element 86 to the output shaft 82 creating a friction coupling. The ramps and lobes are sized so that they cannot slide over each other and cooperate to lock the wedge element 86 to the ring 78.

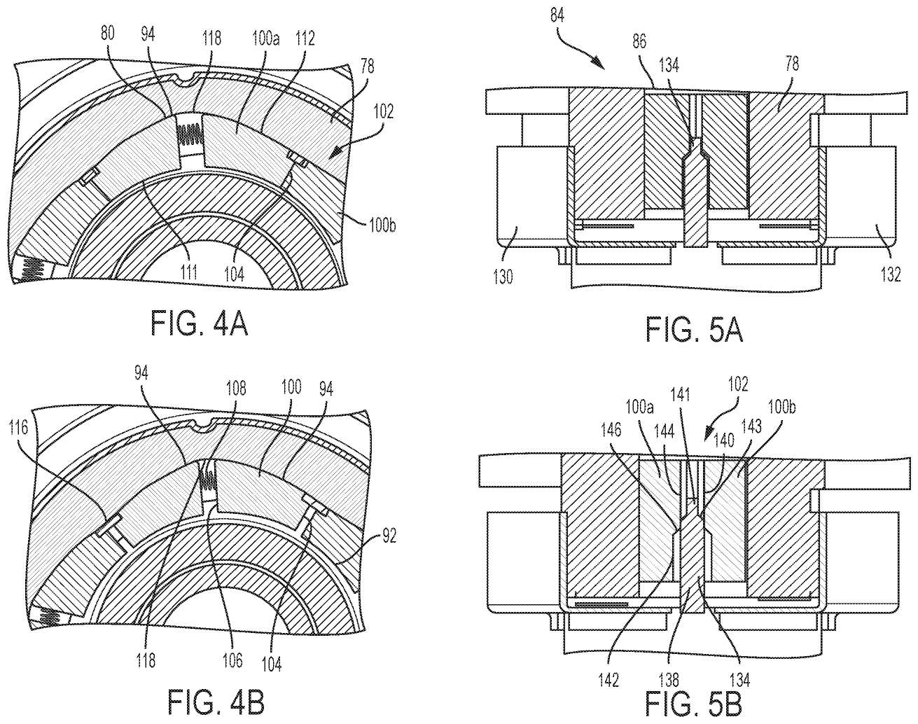

Referring to FIGS. 3, 4A, and 4B, the wedge element 86 may be formed of a plurality of arcuate segments 100 circumferentially arranged around the output shaft 82 to form a cylindrical body 110. The segments 100 are arranged in pairs to form a plurality of arcuate wedge sections 102 of the body 110. Each of the sections 102 includes a first segment 100a and a second segment 100b , which may be mirror images of each other. The segment pairs are arranged with first ends 104 facing each other and with second ends 106 facing away from each other. A plurality of resilient members 108, such as coil springs, are circumferentially arranged between the sections 102. The resilient members 108 bias the segments 100a and 100b towards each other, and bias the sections 102 away from each other. In the illustrated embodiment, there are ten segments arranged into five sections 102 and ten resilient members 108 (two resilient members disposed between each segment). Different amounts of segments, sections, and resilient members may be used in other embodiments.

The thickness of each segment 100 varies between the first and second ends 104, 106 to create the cam surface 92. The second end 106 is thicker than the first end 104 causing the outer surface 112 to slope radially outward from the first end 104 towards the second end 106. The outer surfaces 112 of each segment 100 define a portion of the cam surface 92. The above-mentioned lobes 80 are the outer-most portion of the cam surface 92 and are generally formed by the outer surfaces 112 near the second ends 106. The inner surface 111 of each segment 100 is a smooth arc having a constant radius that substantially matches that of the outer diameter of the output shaft 82.

The cam surface 94 of the ring 78 has a profile that substantially matches the cam surface 92 of the wedge element 86. The cam surface 94 includes radially extending ramps 116 and pockets 118. The matching shapes of the of the cam surfaces 92, 94 allows the wedge element 86 to nest within the ring 78 with the lobes 80 disposed in the pockets 118.

The resilient members 108 bias the wedge element 86 to the contracted position in which each of the segments 100 are in frictional contact with the output shaft 82 creating sufficient drag to rotate the wedge element 86 relative to the ring 78 if the ring gear 54 and/or the output shaft 82 is rotated. Relative rotation between the ring 78 and the wedge element 86 misaligns the cam surfaces 92, 94, i.e., the ramps 116 slide into the lobes 80, causing further radial contraction of the wedge element 86. This further radial contraction clamps the wedge element 86 onto the output shaft 82 with sufficient friction force to rotationally lock the ring 78 to the output shaft 82, which engages the clutch 84.

Referring to FIGS. 4A through 5B, the clutch 84 can be disengaged by separating the segments 100a and 100b of each pair to move the wedge element 86 to the expanded position as shown in FIG. 4B. In one or more embodiments, the clutch 84 includes a clutch cage 130 that moves the wedge element 86 between the contracted and expanded positions. The clutch cage 130 may include an outer ring 132 slidably received on an outer surface of the axially extending ring 78. The clutch cage 130 may also include a plurality of axially extending fingers 134 disposed in slots 140 of the sections 102. The fingers 134 are circumferentially arranged and are disposed radially inboard of the outer ring 132. The number of fingers 134 may be equal to the number of sections 102 and in the illustrated embodiment, the clutch cage 130 has five fingers 134.

Each of the slots 140 is recessed into a corresponding one of the sections 102 with the first segment 100a defining one half of the slot and the second segment 100b defining the other half of the slot. Each slot 140 includes a first portion 142, a second portion 144 that is narrower than the first portion, and a sloped portion 146 that transitions between the first and second portions 142, 144. The fingers 134 have a shape that substantially matches the slots 140. Each of fingers 134 may include a main portion 138 and a tip 141. The main portion 138 is sized to snugly fit within the first portion 142 and the tip 141 is sized to snuggly fit within the second portion 144. The fingers 134 also include angled sides 143 that match the sloped portions 146 of the slots.

Axial movement of the clutch cage 130 towards the wedge element 86 disengages the clutch 84 by driving the angled sides 143 into the sloped portion 146 to separate the segments pairs 100a and 100b of each section 102 moving the clutch element 85 to the expanded position. The amount of separation can be tuned by adjusting the width of the fingers 134 and the slots 140. The axial force required to separate the segments pairs can be adjusted by modifying the slope of the angled sides 143 and the sloped portions 146. The clutch 84 can be re-engaged by retracting the clutch cage 130 and rotating the wedge element 86 relative to the ring 78.

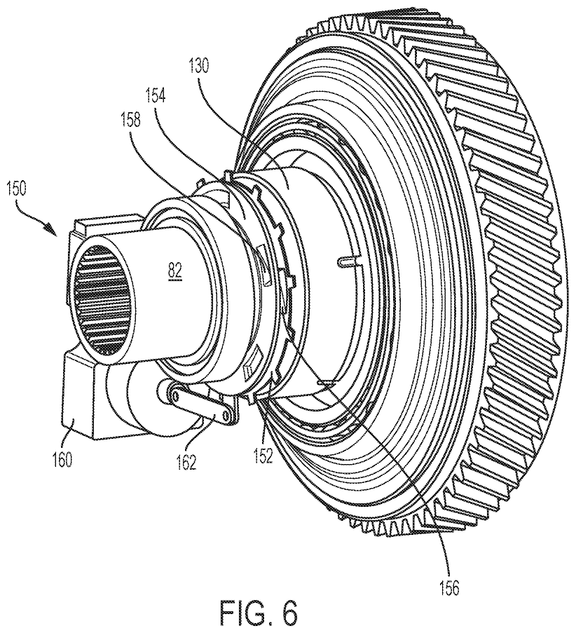

Referring to FIG. 6, the clutch cage 130 may be operated by an actuator arrangement 150 that includes a first plate 152 and a second plate 154 disposed on the output shaft 82 adjacent to the clutch cage 130. The first plate 152 may be rotationally fixed to the housing 52 and the second plate 154 may be axially fixed to the housing 52, or vice versa. The first and second plates 152, 154 define opposing ramps 156 and 158, respectively. In the illustrated embodiment, rotation of the second plate 154 in the counterclockwise direction causes the ramps 156 and 158 to ride-up on each other urging the first plate 152 into the clutch cage 130, which in turn moves the wedge element 86 to the expanded position to disengage the clutch 84. Rotating the second plate 154 in the clockwise direction releases the pressure on the clutch cage 130 allowing the wedge element 86 to return to the contracted position in which the clutch 84 is capable of engaging. At least one resilient member, such as springs, may be used to urge the cage 130 away from the wedge element 86. The resilient member may be disposed between the ring 78 and the cage 130.

The second plate 154 may be driven by a linear actuator 160 that includes an electric motor and a gear train configured to convert rotational motion of the rotor into linear movement. A linkage 162 may connect between the second plate 154 and the linear actuator 160.

The above-described actuator arrangement is but one example embodiment and is not limiting. Any actuator arrangement capable of axial displacement may be used to drive the clutch cage. For example, a ball-ramp mechanism or a hydraulically actuated position may be used.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation.

Parts List:

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

vehicle 20

engine 22

transmission 24

front differential 26

power transfer unit 28

axle shafts 30, 32

driveshaft 34

rear differential 36

rear axle shafts 38, 40

front differential 50

a housing 52

input member 54

axle hubs 56, 58

differential mechanism 60

sun gears 62, 64

first planetary set 66

planet gears 68

second planetary set 70

planet gears 72

first side plate 74

second side plate 76

axially extending ring 78

lobes 80

output shaft 82

disconnect clutch 84

wedge element 86

projections 88

grooves 90

cammed surface 92

first cam surface 94

segments 100

section 102

first end 104

second end 106

springs 108

cylindrical body 110

outer surface 112

inner surface 114

ramps 116

pockets 118

clutch cage 130

outer ring 132

fingers 134

end face 136

main portion 138

slots 140

tip 141

first portion 142

angled sides 143

second portion 144

sloped portion 146

clutch-cage actuator arrangement 150

first plate 152

a second plate 154

ramp 156

ramp 158

linear actuator 160

linkage 162

1. A front differential for use with an all-wheel-drive vehicle, the differential comprising:
an input member;
first and second axle hubs operably coupled to the input member by a differential mechanism;
an output member configured to power rear wheels of the vehicle; and
a wedge clutch configured to selectively couple the input and output members, the wedge clutch including an outer race fixed to the input member, an inner race fixed to the output member, and a wedge element radially disposed between the inner and outer races and actuatable to couple the inner and outer races creating a power flow path between the input and output members.

2. The differential of claim 1, wherein the wedge element has a contracted position in which the inner and outer races are coupled, and an expanded position in which the inner and outer races are decoupled.

3. The differential of claim 1, wherein the differential mechanism is a planetary differential mechanism.

4. The differential of claim 3, wherein the planetary differential mechanism includes:
first and second sun gears fixed to the first and second axle hubs, respectively,
a first set of planet gears in meshing engagement with the first sun gear,
a first planet carrier fixed to the input member and supporting the first planet gears,
a second set of planet gears in meshing engagement with the second sun gear, and
a second planet carrier fixed to the input member and supporting the second planet gears.

5. The differential of claim 1, wherein the inner race is formed on the output member.

6. The differential of claim 1, wherein the inner race defines a plurality of axially spaced circular grooves, and the wedge element has a plurality of axially spaced rings that are received in the grooves.

7. The differential of claim 1, wherein the outer race includes an inner cam surface defining ramps, and the wedge element defines lobes that cooperate with the ramps to clamp the wedge element onto the inner race in response to relative rotation between the outer race and the wedge element.

8. The differential of claim 1, wherein the wedge element has a plurality of arcuate sections collectively defining a cylinder that encircles the output member, and resilient members interposed with the sections.

9. The differential of claim 8, wherein each of the sections includes first and second arcuate segments circumferentially movable relative to each other, wherein the cylinder contracts to engage the wedge clutch in response to the first and second arcuate segments moving circumferentially towards each other, and the cylinder expands to disengage the wedge clutch in response to the first and second pieces moving circumferentially away from each other.

10. The differential of claim 9, wherein the wedge clutch further includes a clutch cage engaging with each of the segments of the plurality of arcuate sections and configured to circumferentially move the segments in response to axially movement of the clutch cage.

11. The differential of claim 10 further comprising a clutch-cage actuator arrangement including a first plate adjacent the clutch cage and rotational fixed to a housing of the differential and a second plate opposite the first plate and axially fixed to the housing, the first and second plates including cooperating ramps that axially move the first plate into the clutch cage in response to rotation of the second plate.

12. A differential comprising:
an input member;
first and second axle hubs supported for independent rotation relative to each other and operably coupled to the input member;
an output shaft configured to connect with a power-transfer unit, the output shaft circumscribing the second axle hub and including an outer surface defining at least one groove;
a side plate fixed to the input member and defining an axially extending ring circumscribing the output shaft, wherein the ring defines a first cam surface; and
a clutch element radially disposed between the output shaft and the ring, the clutch element including at least one projection received in the at least one groove and a second cam surface engaging the first cam surface.

13. The differential of claim 12, wherein the first and second cam surfaces cooperate to radially contract the clutch element onto the output shaft in response to relative rotation between the ring and the clutch element to couple the output shaft to the input member.

14. The differential of claim 12, wherein the at least one groove is a plurality of axially spaced grooves, and the at least one projection is a plurality of axially spaced projections that are each disposed in one of the grooves.

15. The differential of claim 12, wherein the clutch element is formed of a plurality of arcuate segments circumferentially arranged around the output shaft, wherein an outer surface of each segment forms a portion of the second cam surface.

16. The differential of claim 15 further comprising a clutch cage engaging with each of the segments and configured to circumferentially move the segments in response to axially movement of the clutch cage.

17. The differential of claim 12, wherein the input member is a ring gear.

18. A wedge clutch comprising:
an inner race;
an outer race circumscribing the inner race; and
a plurality of arcuate segments arranged in pairs and circumferentially disposed around the inner race such that each pair forms a section of a wedge cylinder that includes springs disposed between the sections to bias the arcuate segments of each pair towards each other, wherein the springs bias the arcuate segments of each pair towards each other to contract the wedge cylinder onto the inner race so that the races lock in response to relative rotation between the outer race and the wedge cylinder.

19. The wedge clutch of claim 18 further comprising a cage engaging with the arcuate segments of each pair such that axial movement of the cage towards the wedge cylinder moves the arcuate segments of each pair away from each other to expand the wedge cylinder and disengage the races.

20. The wedge clutch of claim 19, wherein the arcuate segments of each pair cooperate to define a variable width slot, and the cage defines variable width fingers, that are each disposed in one of the slots, wherein the fingers engage the slots to move the arcuate segments of each pair away from each other in response to axial movement of the cage towards the wedge cylinder.
